(19) United States
(12) Patent Application Publication
(10) Pub. No.: US 2009/0041394 A1
(43) Pub. Date: Feb. 12, 2009

(54) TUBULAR POUCH HAVING A TUBULAR POUCH BODY AND A SEALED-IN BASE

(76) Inventor: Andreas Michalsky, Memmingen (DE)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 11/547,440

(22) PCT Filed: Feb. 24, 2005
(86) PCT No.: PCT/EP2005/001960

§ 371 Date: Sep. 23, 2008

(30) Foreign Application Priority Data
Mar. 31, 2004 (DE) 10 2004 015 958.0
May 6, 2004 (DE) 10 2004 022 374.2

(51) Int. Cl. B65D 30/10; B31B 39/00

(52) U.S. Cl. 383/121; 493/210

(57) ABSTRACT

The invention relates to a tubular pouch having a tubular pouch body and a sealed-in base, especially a sealed-in standing base, wherein the base a) is made from a tube portion of the same material as the tubular pouch body; b) is inserted into the tubular pouch body under stress; c) has a fin seal pointing in the direction of the tubular pouch body. The invention furthermore relates to a method of producing such a tubular pouch, which comprises the following steps:
a) separating off a tube portion (40) from the tube forming the tubular pouch body (20);
b) sealing an open end (90) of the tube portion (40) by means of a fin seal (50);
c) introducing the sealed tube portion end (80) into the tubular pouch body (20), the sealed tube portion end (80) pointing in the direction of the tubular pouch body (20); and
d) sealing the border (100) of the tube portion (40) to the border (101) of the tubular pouch body (20).

The invention relates to a tubular pouch having a tubular pouch body and a sealed-in base, in accordance with the preamble of patent claim 1, and also to a method of producing such a tubular pouch, in accordance with the preamble of patent claim 8.

Tubular pouches of the mentioned generic kind have been used for some time for the filling and packaging of contents that are solid, in paste form or liquid. Because of their low weight, their generally being economical to manufacture and their being able to be disposed of in relatively problem-free manner, tubular pouches of the mentioned kind are popular and, in many spheres, they have become established over other packagings of glass, metal or cardboard.

However, hitherto customary tubular pouches have some disadvantages which adversely affect or restrict their use in certain areas. These include, amongst others, low standing stability, this disadvantage coming into play especially once the tubular pouch has been opened so that, if the pouch falls over or topples over, it is to be feared that the contents will run out.

In the past, this problem has frequently been solved by making the tubular pouch base from a rigid material and then integrating it into the tubular pouch. However, this results in further disadvantages. For example, the separate standing base first had to be produced by expensive means. In addition, its volume when being disposed of was considerably increased because of the rigid standing base, which was not itself capable of being folded or rolled up.

A further disadvantage of using a separate standing base made from a material different to the tubular pouch itself lies in a lower recycling rate caused by the heterogeneous nature of the materials.

That disadvantage was countered by a standing base made from the same material as the tubular pouch. However, those standing bases, which usually were of V-shaped or W-shaped construction, were expensive to manufacture and again ensured only unsatisfactory standing stability.

The problem of the present invention is to make available a tubular pouch which is economical and simple to manufacture, which avoids heterogeneity of materials in respect of the tubular pouch body and the standing base and which, in addition, has an increased recycling rate.

The problem is solved by a tubular pouch having a tubular pouch body and a sealed-in base, in accordance with patent claim 1 or 2, and also by a method of producing such a tubular pouch, in accordance with patent claim 10 or 11.

More specifically, the problem is solved by a tubular pouch having a tubular pouch body and a sealed-in base, especially a sealed-in standing base, wherein the base a) consists of a tube portion of the same material as the tubular pouch body; b) is inserted into the tubular pouch body under stress; and c) has a fin seal pointing in the direction of the tubular pouch body.

In accordance with an alternative embodiment, the problem is solved by a tubular pouch having a tubular pouch body and a sealed-in base, especially a sealed-in standing base, wherein the base a) consists of a tube portion of the same material as the tubular pouch body; b) is inserted into the tubular pouch body under stress; and c) has a fin seal pointing towards the outside of the tubular pouch body.

The basic core of the invention lies in the fact that, in order to ensure that the pouch is economical and simple to manufacture and for a good recycling capability or high recycling rate of the tubular pouch according to the invention, the base of the tubular pouch is made from a tube portion of the same material as the tubular pouch body itself. This means, in other words, that the base of the tubular pouch and the tubular pouch body are produced from one tube, with a tube portion being separated off from the tube in order to make the base.

Before being separated off or, alternatively, after being separated off, the tube portion forming the base is closed at one of its open ends by means of a fin seal and is then inserted into the tubular pouch body under stress so that the fin seal points in the direction of the tubular pouch body.

In accordance with the above-mentioned alternative embodiment, the tube portion forming the base is inserted into the tubular pouch body so that the fin seal of the tube portion points towards the outside of the tubular pouch body. In the case of this variant, the tubular pouch body is placed from above on the almost cup-shaped tube portion forming the base, the tube portion forming the base coming to be located preferably inside the tubular pouch body. Alternatively, however, the tubular pouch body can also be inserted into the cup-shaped tube portion forming the base. At least sub-regions of the respectively associated borders of the tubular pouch body and of the tube portion are sealed to one another around the periphery of the tubular pouch.

The variant in which the tube portion forming the base is provided with a fin seal pointing towards the outside of the tubular pouch body has substantial advantages over hitherto known tubular pouch bases. These lie firstly in the fact that, when the tubular pouch is being filled or if there is pressure build-up within the tubular pouch, reversal of the bulge in the base towards the outside is no longer possible because in the variant according to the invention the base already allows maximum expansion of the internal volume of the pouch. Secondly, this alternative cup-shaped form of tube portion base according to the invention maximises the fill volume of the tubular pouch whilst using the same amount of material. This makes it possible firstly to fill the tubular pouch more easily and also allows greater variability with respect to the materials which are to be placed inside the tubular pouch. Accordingly, the additional space obtained as a result of this optimised arrangement of the fill volume can be utilised as a possible expansion space for filling the tubular pouch with filling material that is capable of expansion. It is accordingly possible, for example, for the expansion space to be minimised to begin with, for example by means of folds, for space-saving, economical transportation, in which case expansion takes place only if required. The enlarged interior of the tubular pouch can of course also be provided immediately with a correspondingly greater amount of filling material.

Inserting the tube portion forming the base into the tubular pouch body under stress ensures that the tubular pouch base assumes a largely and ideally round shape, because the tube portion inserted into the tubular pouch body forces the tubular pouch body radially outwards in uniform manner, a circular shape ensuring the best possible force distribution.

At this point it is to be noted that simultaneous sealing of the tube portion forming the base and separation thereof from the tube also lies within the scope of this invention. In this case, the tube is pressed together by means of a sealing tool and sealed inside-to-inside and is so separated off from the tube using a separate or integrated separating or cutting tool that an open part forming the tubular pouch body and a closed sealed tube portion result.

Because the tube portion forming the base is formed from the same tube as the tubular pouch body itself, it is advantageous for the tubular pouch body to be widened out radially before the sealed tube portion is introduced into the tubular pouch body, this being so carried out that the widening-out is reversible. After the tube portion having a sealed tube portion end has been introduced sufficiently far into the tubular pouch body, the tubular pouch body can recover itself so that it fits closely around the sealed tube portion.

If it is intended to insert the tubular pouch body into the afore-mentioned cup-shaped tube portion forming the base, the tube portion forming the base is, vice versa, widened out somewhat, in reversible manner, so that introduction of the tubular pouch body into the cup-shaped base tube portion is possible. After introduction of the tubular pouch body, the cup-shaped base tube portion recovers itself to the extent that close contact is ensured between the tube portion forming the base and the tubular pouch body.

A further substantial advantage arising from the use of a cup-shaped tube portion forming the base lies in the fact that, in this case, full-area sealing of the mutually associated borders of the tube portion and of the tubular pouch body is not necessary. Instead, it is sufficient for the border of the tube portion to be sealed to the border of the tubular pouch body in only a sub-region. The latter is preferably in a border region, remote from the standing surface, of the tube portion forming the base.

Insofar as the tubular pouch body is arranged inside the cup-shaped base tube portion, when the tubular pouch is in the filled state the internal pressure of the filling material acting on the wall of the tubular pouch furthermore ensures close contact of the tubular pouch body against the cup-shaped base tube portion, which in turn increases the standing stability of the tubular pouch according to the invention.

The standing base of the tubular pouch according to the invention is accordingly formed by a tubular pouch portion in a two-layer arrangement close to the bottom, the borders thereof being composed of the border of the tube portion and the border of the tubular pouch body. In accordance with the invention, those two borders are sealed to one another in order, as a result, to seal off the tubular pouch to the bottom and, in addition, to provide a strengthened base region having especially good standing stability.

In respect of the tube from which the tube portion forming the base and also the tubular pouch body are formed, the base is sealed into the tubular pouch body, in accordance with the invention, by means of an inside-to-outside seal.

In accordance with an embodiment of the invention, the fin seal is formed by means of an inside-to-inside seal of the tube portion. In this embodiment, the tube portion forming the base is pressed together at its open end and sealed, and therefore closed, with the aid of ultrasound or thermal energy. The advantage of this embodiment lies in the simplicity of sealing the tube portion by simply pressing together and subsequently sealing an inside layer of the tube capable of being sealed inside-to-inside.

In accordance with an alternative embodiment, the fin seal is formed by means of an outside-to-outside seal of the tube portion. For this purpose, in accordance with the invention, that part of the tube portion to be subsequently sealed is first folded over towards the inside and is then closed in the manner for a fin seal. The advantage according to the invention lies in the fact that, after introduction of the sealed tubular pouch end, the contents of the tubular pouch do not come into contact with the resulting cut edges. This is especially significant when the filling material does not behave inertly with respect to other layers of a laminate forming the tube. As a result of the cut edges having been folded back on themselves beforehand, they come to be located on the outside of the tubular pouch after insertion of the sealed tube portion into the tubular pouch body and are not accessible to a possibly corrosive filling material and cannot be attacked thereby or, vice versa, cannot contaminate a filling material.

This is extremely advantageous, for example, when a barrier layer of aluminium and an acidic filling material is used, which barrier layer would, in the case of conventional tubular pouches, be attacked by the acid.

Such a barrier layer can be made from ethyl vinyl alcohol (EVOH), silicon dioxide (SiO₂) or an aluminium foil. This barrier layer is advantageously provided both in the tubular pouch body and also in the base of the tubular pouch.

In accordance with the invention, the tubular pouch body and also the tube portion are formed from a tube which has been either formed with a lap seal or extruded in tube form.

The advantage therein lies in the fact that a completely round shape having standing stability is possible as a result for the tubular pouch body and the finished tubular pouch.

As already mentioned hereinbefore, the cut edges of the tubular pouch body and of the tube portion are arranged not to come into contact with the interior of the tubular pouch, so that the cut edges cannot be attacked by the filling material and, as a result, for example, a barrier layer lastingly retains its barrier action. Especially when EVOH is used, this is a substantial advantage because EVOH is sensitive to moisture and, in the event of access by moisture, its barrier action diminishes or is lost.

In accordance with the invention, the sealed tube portion end is sealed in a concertina and/or angled arrangement. This measure is advantageous so that a tube portion end which is formed wider than the tubular pouch body as a result of the formation of the afore-mentioned fin seal can be introduced well and in closely contacting manner into the tubular pouch body with the fin seal to the forefront. For that purpose, the fin seal is provided with a concertina arrangement along its longitudinal extent so that the sealed seam is folded and/or corrugated. In an alternative embodiment, the tube portion to be sealed is first fixed in the shape of the desired later diameter and then sealed. A further alternative comprises angled sealing of the corner regions of the fin seal.

As already mentioned, the problem according to the invention is also solved by a method of producing a tubular pouch having a tubular pouch body and a sealed-in base, wherein the following steps are provided:
a) separating off a tube portion from the tube forming the tubular pouch body;
b) sealing an open end of the tube portion by means of a fin seal;
c) introducing the sealed tube portion end into the tubular pouch body, the sealed tube portion end pointing in the direction of the tubular pouch body;
d) sealing the border of the tube portion to the border of the tubular pouch body.

The problem according to the invention is furthermore solved by an alternative method thereto, wherein in step c) the sealed tube portion end is so introduced into the tubular pouch body that the sealed tube portion end points towards the outside of the tubular pouch body.

It should be emphasised at this point that, in accordance with the invention, step b) can be carried out before step a) or simultaneously with step a).

Further embodiments of the invention are to be found in the subordinate claims.

The invention will be described hereinbelow with reference to an exemplary embodiment explained in greater detail with reference to the drawings, in which:

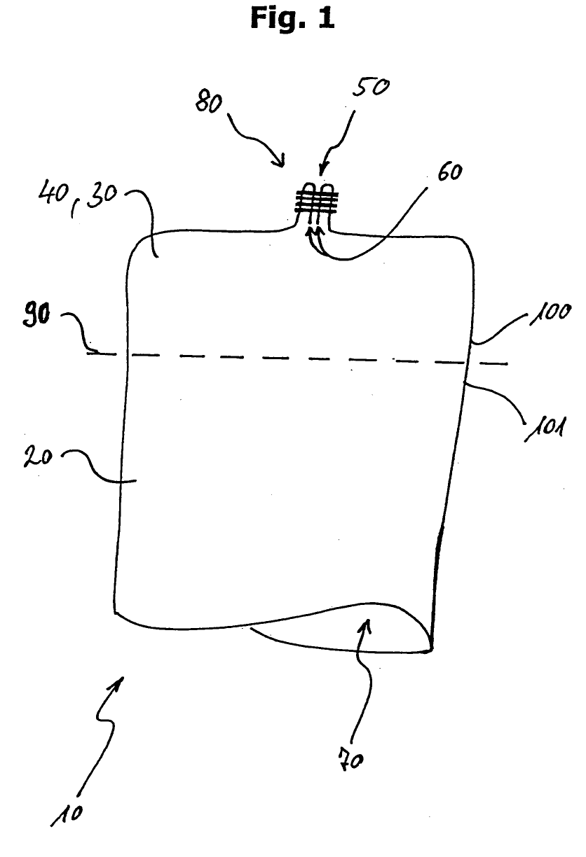

FIG. 1 shows, in diagrammatic form, a procedure according to the invention for producing a tubular pouch having a standing base;

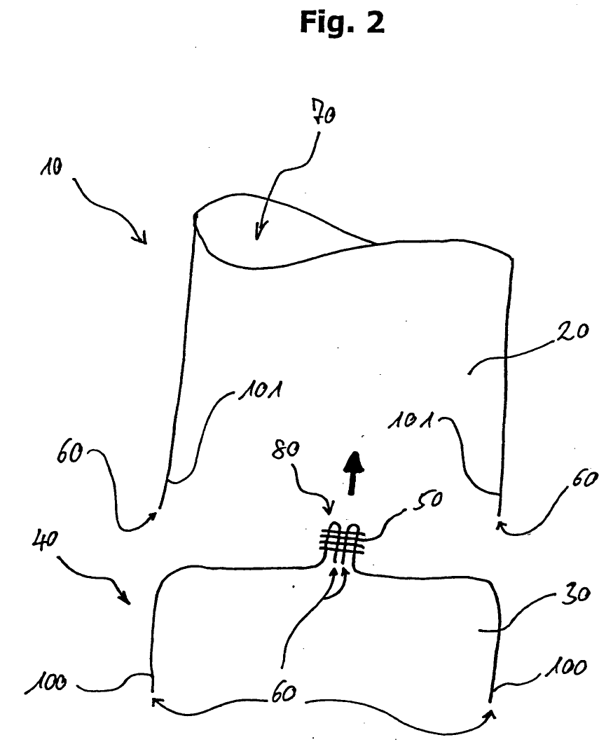

FIG. 2 shows, in diagrammatic form, production of a tubular pouch according to the invention;

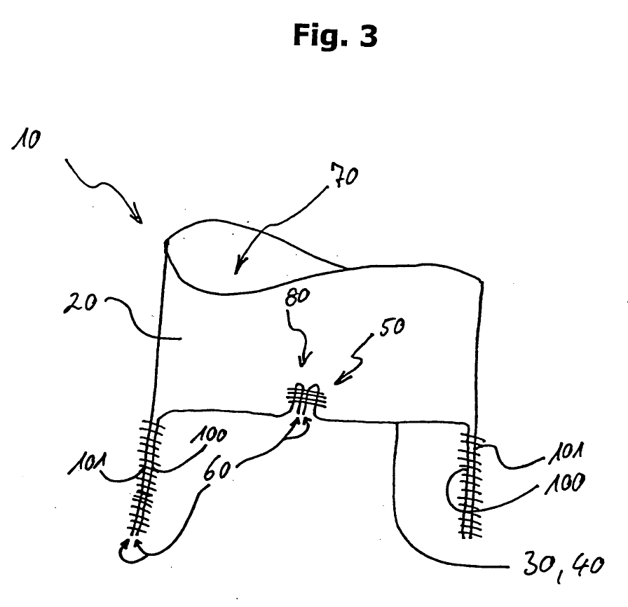

FIG. 3 shows, in diagrammatic form, a standing base sealed in accordance with the invention.

In the description that follows, the same reference numerals are used for parts that are the same or that act in the same way.

FIG. 1 shows, in diagrammatic form, a procedure for producing a tubular pouch 10 according to the invention, which is made from a tube. The tube is closed by means of a fin seal at a tube portion end 80, the ends of the tube having been turned back on themselves before sealing so that cut edges 60 point in the direction of the tube portion 40. The tube portion 40, which is shown as being separate from the tubular pouch body 20 by a cutting line 90 shown in diagrammatic form, is used to produce the base 30.

FIG. 2 shows the tube portion 40 forming the base 30, which is now in the form of a separate part having been separated off. The base 30 is introduced into the tubular pouch body 20 with the fin seal 50 to the forefront so that the tube portion end 80 comes to be located in the interior 70 of the tubular pouch 10. This is symbolised by the broad arrow in the middle of the Figure.

FIG. 3 finally shows, in diagrammatic form, a sealed-in base 30 according to the invention. The seals are indicated, in diagrammatic form, by oblique lines. As can be seen, the border of the tube portion 100 is sealed to the border of the tubular pouch body 101. For the purpose of allowing better representation, the border 100 of the tube portion is not shown directly adjacent to the border 101 of the tubular pouch body. It can clearly be seen that cut edges 60 of both the tube portion 40 and also of the tubular pouch body 20 are not in contact with the interior 70 of the tubular pouch 10.

At this point it should be stated that all above-described parts, considered on their own and in any combination, especially the details shown in the drawings, are claimed as being important for the invention. The skilled person will be familiar with modifications thereof.

### LIST OF REFERENCE NUMERALS

10 tubular pouch
20 tubular pouch body
30 base
40 tube region
50 fin seal
60 cut edges
70 interior
80 tube portion end
90 cutting line
100 border of tube portion
101 border of tubular pouch body

1-16. (canceled)

17. A tubular pouch having a tubular pouch body and a base selected from the group consisting of a sealed-in base, and a sealed-in standing base, wherein the base
a) is made from a tube portion of the same material as the tubular pouch body;
b) is inserted into the tubular pouch body under stress; and
c) has a seal selected from the group consisting of a fin seal pointing in the direction of the tubular pouch body, and a fin seal pointing towards the outside of the tubular pouch body.

18. A tubular pouch according to claim 17, wherein the fin seal is formed by inside-to-inside sealing of the tube portion.

19. A tubular pouch according to claim 17, wherein the fin seal is formed by outside-to-outside sealing of the tube portion.

20. A tubular pouch according to claim 17, wherein the base has a barrier layer.

21. A tubular pouch according claim 17, wherein the tubular pouch body and the tube portion are formed from a tube selected from the group consisting of a tube which has been formed with a lap seal, and a tube which has been extruded in tube form.

22. A tubular pouch according to claim 17, wherein cut edges of the tubular pouch body and of the tube portion are so arranged that they are not in contact with the interior of the tubular pouch.

23. A tubular pouch according to claim 17, wherein the sealed tube portion end is sealed in an arrangement selected from the group consisting of a concertina arrangement, an angled arrangement, and a concertina and angled arrangement.

24. A tubular pouch according to claim 17, wherein the border of the tube portion is sealed to the border of the tubular pouch body in only a sub-region.

25. A method of producing a tubular pouch having a tubular pouch body and a sealed-in base, wherein the method comprises the following steps:
a) separating off a tube portion from the tube forming the tubular pouch body;
b) sealing an open end of the tube portion by means of a fin seal;
c) introducing the sealed tube portion end into the tubular pouch body, the sealed tube portion end pointing in a direction selected from the group consisting of the direction of the tubular pouch body, and towards the outside of the tubular pouch body; and
d) sealing the border of the tube portion to the border of the tubular pouch body.

26. A method according to claim 25, wherein step b) is carried out at a time selected from the group consisting of before step a), and simultaneously with step a).

27. A method according to claim 25, wherein the fin seal is formed by inside-to-inside sealing of the tube portion.

28. A method according to claim 25, wherein the fin seal is formed by outside-to-outside sealing of the tube portion.

29. A method according to claim 25, wherein the open end of the tube portion is folded back on itself before sealing.

30. A method according to claim 25, wherein the tubular pouch body is radially expanded before introduction of the sealed tube portion end.

31. A method according to claim 25, wherein the sealed tube portion end is sealed in an arrangement selected from the group consisting of a concertina arrangement, an angled arrangement, and a concertina and angled arrangement.

32. A method according to claim 25, wherein the border of the tube portion is sealed to the border of the tubular pouch body in only a sub-region.
